(19) United States
(12) Patent Application Publication
(10) Pub. No.: US 2026/0262688 A1
(43) Pub. Date: Sep. 10, 2026

(54) METHOD FOR MANUFACTURING FUNCTIONAL KIMCHI USING ECKLONIA CAVA

(71) Applicant: YE BIN HWANG, Suncheon-si (KR)

(72) Inventor: YE BIN HWANG, Suncheon-si (KR)

(21) Appl. No.: 19/557,133

(22) Filed: Mar. 5, 2026

(30) Foreign Application Priority Data
Mar. 5, 2025 (KR) 10-2025-0028038

(51) Int. Cl. A23L 19/20; A23B 2/733; A23B 7/10; A23B 7/154

(52) U.S. Cl. CPC A23L 19/20; A23B 2/733; A23B 7/105; A23B 7/154

(57) ABSTRACT

Provided is a method for manufacturing functional kimchi using Ecklonia cava, which improves storability and unique functionality by simply processing Ecklonia cava, mixing it with common seasoning ingredients, and mixing it with pickled cabbage to reduce the unique odor of kimchi while maintaining its flavor and texture, extending its shelf life, improving the antioxidant, anticancer, and antihypertensive properties of Ecklonia cava, and environmentally friendly removal of harmful compounds that have penetrated crops, including cabbage. The method includes: a process for preparing seasoning ingredients, each including pickled cabbage and Ecklonia cava; a process for preparing a seasoning mixture, for seasoning the pickled cabbage, the seasoning mixture comprising: 1.62 parts by weight of Ecklonia cava powder, 1.53 parts by weight of kelp powder, 1.5 parts by weight of Korean soy sauce, 0.7 parts by weight of yeast cells, 3 parts by weight of minced garlic, 0.6 parts by weight of ginger, 3 parts by weight of red pepper powder, 3.5 parts by weight of salted seafood, 4.32 parts by weight of glutinous rice paste, 2.7 parts by weight of thread onions, and 0.6 parts by weight of sugar, based on 100 parts by weight of pickled cabbage; a seasoning mixing process in which the seasoning mixture prepared in the above-mentioned process for preparing the seasoning mixture is sequentially added to a mixing tank (100) in a designated order, mixing at a rate of 3 to 5 times per second, and mixing for 5 to 10 minutes after the seasoning mixture is completed; a seasoning mixture maturation process in which the seasoning mixture prepared in the above-mentioned seasoning mixing process is stored for 30 to 40 minutes at room temperature of 30 to 35 degrees Celsius and in an environment with a wind speed of 5 meters per second; a cabbage seasoning mixing process in which the seasoning mixture prepared in the above-mentioned seasoning mixing maturation process is uniformly mixed on a surface of pickled cabbage. The method improves storage properties by processing Ecklonia cava and mixes it with readily available seasoning ingredients to produce kimchi using a conventional method, thereby allowing anyone to easily produce functional kimchi. In addition, the method mixes harmless nanoparticle-sized titanium dioxide powder with the ingredients, thereby providing the advantage of environmentally friendly decomposition and removal of various harmful compounds that have penetrated crops during the kimchi fermentation process.

### FIELD

The present invention relates to a method for manufacturing functional kimchi using Ecklonia cava, and more specifically, to a method for manufacturing functional kimchi using Ecklonia cava, which comprises simply processing Ecklonia cava to enhance its storage properties and inherent functionality, mixing it with general seasoning ingredients and mixing it with pickled cabbage, thereby reducing the inherent odor of kimchi while maintaining its taste and texture, extending its storage period, improving the antioxidant, anticancer, and antihypertensive functions of Ecklonia cava, and environmentally friendly removal of harmful compounds that have penetrated crops including cabbage.

### DISCUSSION OF RELATED ART

As economic and medical advancements lead to increased life expectancy, the proportion of the elderly population is increasing. Furthermore, with the rise in chronic adult diseases and illnesses, there is growing interest in health for their prevention and treatment. Consequently, functional foods are increasingly preferred over flavor.

Furthermore, industrialization has led to the introduction of large quantities of hazardous compounds, including NOx and SOX, into the atmosphere. These compounds are then transported to crops like cabbage through agricultural water and rain, potentially harming humans who consume these crops.

Ecklonia cava is a perennial seaweed belonging to the brown algae family, and grows natively along the southern coast of Korea, including the southern East Sea and Jeju Island. It contains the polyphenol compound phlorotannin, which is known to have antioxidant, anticancer, and antihypertensive properties (Lee Seung-hong et al., Journal of the Korean Society of Food Science and Nutrition, 2006, 35(9), pp. 1139-1145).

Japanese Patent Laid-Open No. 2006-238825 discloses a method of alleviating and removing astringent and bitter tastes by placing Ecklonia cava in a solution containing 2-3% edible vinegar, but this method uses Ecklonia cava for food purposes. Korean Patent No. 0704447 discloses a method of crushing kimchi ingredients, adding kimchi lactic acid bacteria, fermenting the ingredients, and coating the resulting mixture with Ecklonia cava to form particles.

Kimchi, along with rice, occupies a crucial position in the Korean diet. It is a traditional Korean fermented food made by salting vegetables such as cabbage and radish, adding spices like garlic and red pepper, and fermenting them with other ingredients like salted seafood [Bang, B. H. et al., Korean J Food Nutr. (2008), 21:51-55].

Compared to other health functional foods, kimchi has a relatively short shelf life. It has a very strong flavor and unique aroma. It contains vitamins, amino acids, minerals, fiber, various organic acids produced by lactic acid microorganisms, and microbial metabolites. It has been reported to have anti-aging, anti-cancer, anti-arteriosclerosis, antibacterial, and probiotic-producing effects [Sim, K. H. et al., Food Sci. Biotechnol. (2008), 17:295-301; Kim, Y. J. et al., Food Sci. Biotechnol. (2000), 9:89-94; Lee, J. J. et al., Korean J. Food Preserv. (2008), 15:760-768; Kim, M. et al., Korean J. Microbiol. Biotechnol. (2009), 37:24-32].

Therefore, there is a need to develop technologies that extend the shelf life or storage time of kimchi, reduce its strong flavor and unique aroma, and maintain or improve its sensory characteristics.

Meanwhile, kimchi is a well-known food internationally. Japan has developed sukemono (pickled vegetables), a Japanese-style kimchi, by identifying lactic acid bacteria associated with the unique flavor of kimchi and adding them to it. The United States is reportedly building a kimchi museum at the government level.

Furthermore, the aftermath of the SARS (Severe Acute Respiratory Syndrome) and avian influenza epidemics, which had been prevalent for a while, has led to increased interest in kimchi overseas, with exports to Japan, China, Taiwan, Hong Kong, and Singapore increasing significantly.

Various microorganisms, including kimchi lactic acid bacteria, have developed useful products, such as antimicrobial peptides. Research is currently underway worldwide on using microorganisms to improve antibiotic toxicity and resistance, prevent food poisoning, develop natural preservatives, and naturally treat infectious diseases. a method for manufacturing functional kimchi using Ecklonia cava

A prior art that partially addresses these problems and needs is “Method for Manufacturing Kimchi Using Ecklonia cava and Kimchi Made Therefrom,” registered in the Republic of Korea as a patent (No. 10-1443517, Sep. 16, 2014).

FIG. 1 illustrates the results of a sensory evaluation of a method for manufacturing functional kimchi using Ecklonia cava, according to an embodiment of the prior art.

Hereinafter, with reference to the attached drawings, a prior art technique will be described in detail. Softened Ecklonia cava is prepared by soaking Ecklonia cava in a 3 wt % citric acid solution for 2-3 hours or heating at 90-100° C. for 10 minutes.

Furthermore, cabbage soaked in 10 wt % salt water for 12-14 hours is washed and naturally dehydrated for 2-3 hours to prepare pickled cabbage with a salinity of 1.7-1.9 wt %.

Based on 100 parts by weight of the pickled cabbage, 3 parts by weight of garlic, 6 parts by weight of ginger, 3 parts by weight of red pepper powder, 3.5 parts by weight of salted seafood, 4.32 parts by weight of glutinous rice paste, 2.7 parts by weight of green onions, and 0.6 parts by weight of sugar are added. Kimchi is prepared by adding 5-25 wt % of the softened Ecklonia cava to the total mixed weight.

Conventional techniques have been shown to maintain the chewy texture and flavor while reducing the sourness and pungent odor. However, they suffer from the unconventional method of softening Ecklonia cava and the relatively time-consuming nature of the process. Furthermore, conventional techniques require the addition of a new ingredient, citric acid, to kimchi production, which is costly and time-consuming, and requires meticulous management.

Therefore, there is a need to develop a technology that utilizes readily available ingredients and the same conventional kimchi-making method, preserving sensory properties while extending storage time.

### PRIOR ART DOCUMENT

### Patent Document

(Patent Document 1) Republic of Korea Patent Registration No. 10-1443517 (Sep. 16, 2014) “Method for Manufacturing Kimchi Using Ecklonia Cava and Kimchi Made Therefrom”

### SUMMARY OF THE INVENTION

### Problem to Be Solved

The present invention, conceived to address the problems and needs of the prior art described above, aims to provide a method for manufacturing functional kimchi using Ecklonia cava, which allows anyone to easily make functional kimchi by processing Ecklonia cava to improve its storage properties and mixing it with readily available seasoning ingredients. This method allows for the production of kimchi using Ecklonia cava in a standard manner.

Furthermore, the present invention provides a method for manufacturing functional kimchi using Ecklonia cava that decomposes and removes harmful compounds in various crops in an environmentally friendly manner by mixing it with edible, human-safe nanoparticle-sized titanium dioxide powder.

### Solution to the Problem

In order to achieve the above-mentioned object, the present invention provides a method for manufacturing functional kimchi using Ecklonia cava, comprising: a material preparation process for preparing salted cabbage and seasoning ingredients including Ecklonia cava; a seasoning mixture composition process for seasoning the salted cabbage, comprising, based on 100 parts by weight of salted cabbage, 12.2 parts by weight of Ecklonia cava powder, 1.3 parts by weight of kelp powder, 7 parts by weight of seaweed powder, 1 part by weight of shiitake mushroom powder, 0.5 parts by weight of Korean soy sauce, 0.7 parts by weight of yeast cells, 20 parts by weight of minced garlic, 5 parts by weight of ginger, 12 parts by weight of red pepper powder, 25 parts by weight of salted seafood, 4.32 parts by weight of glutinous rice paste, 6 parts by weight of green onion, 6 parts by weight of green onion, 5 parts by weight of plum enzyme solution, 5 parts by weight of raw water parsley, 20 parts by weight of onion, 10 parts by weight of apple, and 5 parts by weight of sugar; The method may include: a seasoning mixing process in which the seasoning mixture prepared in the above process is sequentially added to the mixing tank 100 in a designated order, mixing at a rate of 3 to 5 times per second, and mixing for 5 to 10 minutes after the seasoning mixture is completed; a seasoning mixture maturation process in which the seasoning mixture prepared in the above seasoning mixing process is stored for 30 to 40 minutes at a room temperature of 30 to 35 degrees Celsius and a wind blowing at 5 meters per second; and a cabbage seasoning mixing process in which the seasoning mixture prepared in the above seasoning mixing process is uniformly mixed on the surface of the pickled cabbage.

The 25 parts by weight of the salted seafood may be replaced with 10 parts by weight of salted shrimp (salted seafood), 10 parts by weight of salted anchovy (salted seafood), and 5 parts by weight of fish sauce.

The above seasoning mixture further comprises 2.52 parts by weight of a titanium dioxide solution, and the titanium dioxide solution is characterized by comprising a mixture of titanium dioxide (TiO2) powder, comprising nanoparticles having an average diameter of 500 to 700 nanometers (nm), and purified water at a weight ratio of 7 to 1, which is placed in a container and stored for 30 to 40 minutes for maturation.

The Ecklonia cava powder and kelp powder are prepared by: Separating and washing Ecklonia cava and kelp to remove foreign substances, and drying them for 1 to 2 hours in an indoor environment maintained at an internal temperature of 60 to 70 degrees Celsius and with a wind blowing at 4 to 5 meters per second, thereby separating and drying them into a brittle state; and a grinding step in which the dried Ecklonia cava and kelp are separated from each other in the drying step, placed in a mixer or grinder for 50 to 60 minutes, and ground into particles of 1 millimeter or less in diameter.

The pickled cabbage is characterized by a composition produced through a process. The pickled cabbage is made by soaking five heads of raw cabbage in clean water containing 2 kg of sea salt for five hours, washing them, and then allowing them to sit for two hours for dehydration. The seasoning mixing process is characterized by sequentially adding and mixing Joseon-guk soy sauce, yeast cells, minced garlic, ginger, red pepper powder, salted seafood, glutinous rice paste, thread onions, large green onions, plum enzyme solution, raw water parsley, onions, apples, sugar, kelp powder, sea grape powder, shiitake mushroom powder, Ecklonia cava powder, and titanium dioxide solution to the mixing tank 100.

The mixing tank 100 is hemispherical in shape with an open top, forming a container. It comprises a mixing vessel 110 into which the seasoning mixture is added and for applying vibrations to the interior in response to a corresponding control signal; The mixing container 110 may include a container lid 120 that opens and closes the open upper portion by an external force and mixes the seasoning mixture in response to a corresponding control signal; a mixing control unit 130 that is connected to the mixing container 110 and the container lid 120 and outputs a corresponding control signal in response to a command signal;

The mixing container 110 may include a container body 111 having a hemispherical shape that is cut downward and has an open upper portion, forming a container shape; a container rotation axis 112 that protrudes outward in both directions from a portion of the upper side of the container body 111 and is positioned horizontally to form a rotation axis that facilitates vibration of the container body 111; a vibration transmitting protrusion 113 that protrudes downwardly and outwardly from the center of the lower surface of the container body 111; It may include a container vibrator 114 that is connected and installed at the lower end of the vibration transmission protrusion 113 and vibrates 3 to 5 times per second in accordance with the corresponding control signal of the mixing control unit 130.

The container lid 120 has a gently upwardly curved arc shape and comprises: a lid body 121 that opens and closes the open upper end of the mixing container 110 by an external force; a lid handle 122 that protrudes upwardly and outwardly from the central portion of the lid body 121 and has a blunt upper end to receive an external force; an electric motor 123 that is installed on the upper side of the lid handle 122 and rotates at a constant speed in response to a corresponding control signal from the mixing control unit 130 and extends its rotation axis downward through the interior of the lid handle 122 to the lower side of the lid body 121; A mixing spatula part 124 having one shaft fixedly installed at the end of the rotation shaft of the electric motor part 123 and having a rod shape extending downwardly from the lid body part 121 and having a mixing spatula shape fixedly installed at the other end; an ultrasonic vibrator group part 125 having one or more ultrasonic vibrators spaced at equal intervals in a concave portion on the lower side of the lid body part 121 and outputting an ultrasonic signal in response to a corresponding control signal of the mixing control part 130; an exhaust hole 126 formed through a concentric circumferential position of the lid body part 121 and discharging steam generated in the mixing container part 110 to the outside; a fixing protrusion 127 formed on the lower surface of the lid body 121 and protruding from the outer edge of the discharge hole 126, thereby contacting the upper inner surface of the mixing container 110 and supporting the lid body 121 from slipping.

The fixing protrusion 127 is characterized by being configured to protrude 2 to 3 millimeters high, thereby preventing slipping even if the container lid 120 is deformed.

### Effects of the Invention

The present invention, with the above configuration, improves storage properties by processing Ecklonia cava and mixes it with readily available seasoning ingredients to produce kimchi using a conventional method, thereby allowing anyone to easily produce functional kimchi.

Meanwhile, the present invention mixes harmless nanoparticle-sized titanium dioxide powder with the ingredients, thereby providing the advantage of environmentally friendly decomposition and removal of various harmful compounds that have penetrated crops during the kimchi fermentation process.

### BRIEF DESCRIPTION OF DRAWINGS

FIG. 1 illustrates the sensory evaluation results of a method for manufacturing functional kimchi using Ecklonia cava according to an embodiment of the prior art.

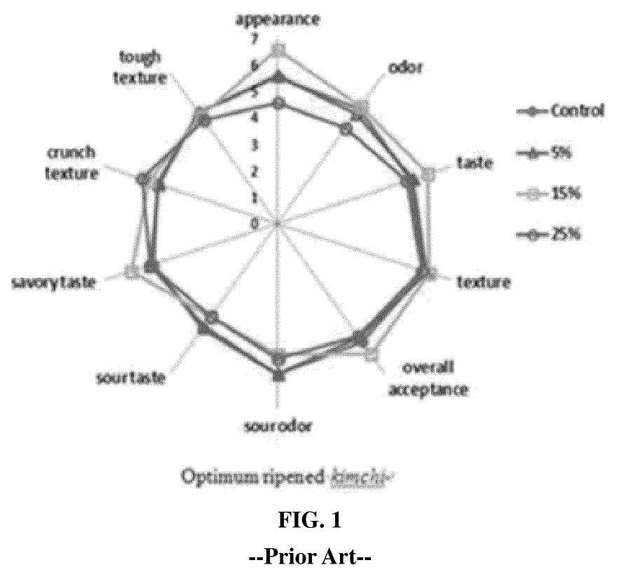

FIG. 2 illustrates a flowchart of a method for manufacturing functional kimchi using Ecklonia cava according to an embodiment of the present invention.

FIG. 3 illustrates a detailed functional configuration of a mixing tank according to an embodiment of the present invention.

FIG. 4 illustrates a detailed functional configuration of a mixing container according to an embodiment of the present invention.

FIG. 5 illustrates a detailed functional configuration of a container lid according to an embodiment of the present invention.

### SPECIFIC DETAILS FOR CARRYING OUT THE INVENTION

The present invention is susceptible to various modifications and embodiments. Specific embodiments are illustrated in the drawings and described in detail in the detailed description. However, this is not intended to limit the present invention to specific embodiments, but rather to encompass all modifications, equivalents, and alternatives falling within the spirit and scope of the present invention. In describing the present invention, detailed descriptions of related known technologies will be omitted if they are deemed to obscure the gist of the present invention.

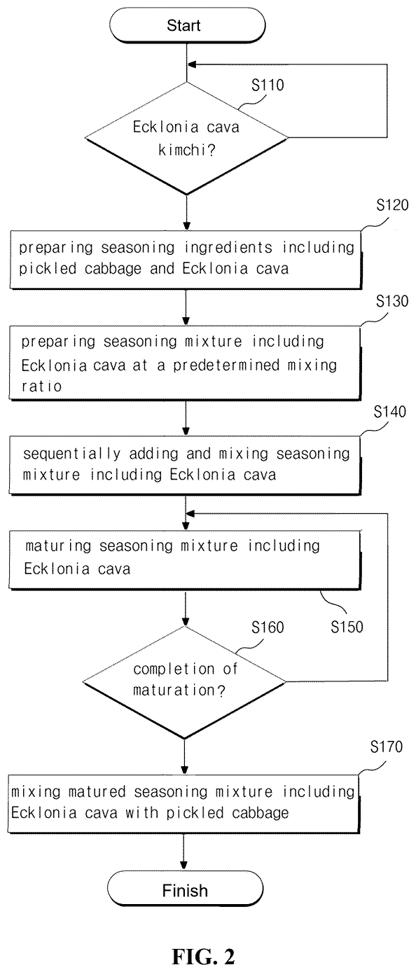

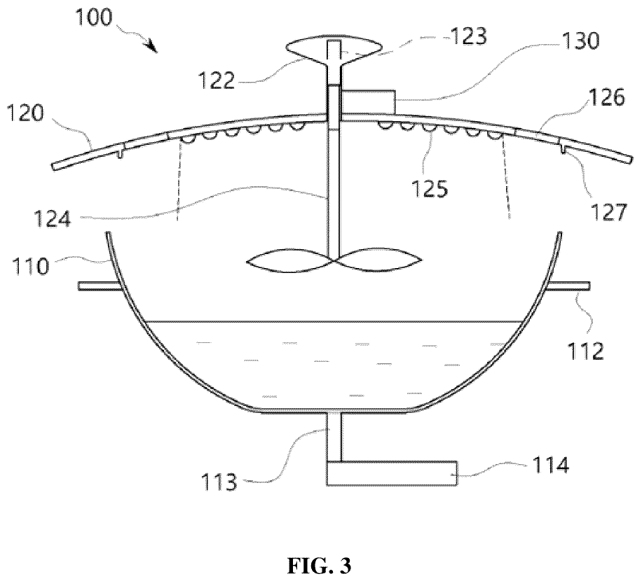

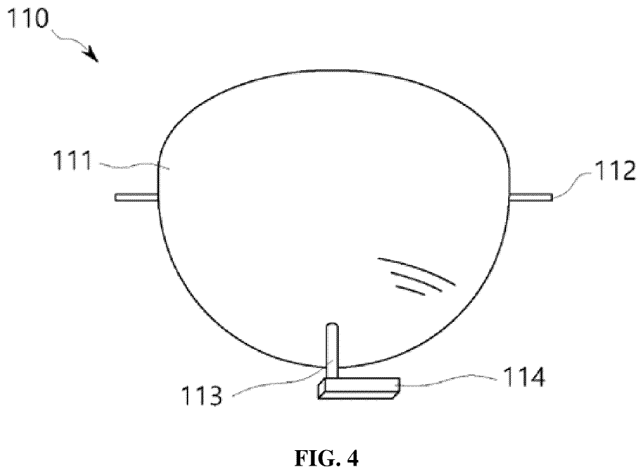

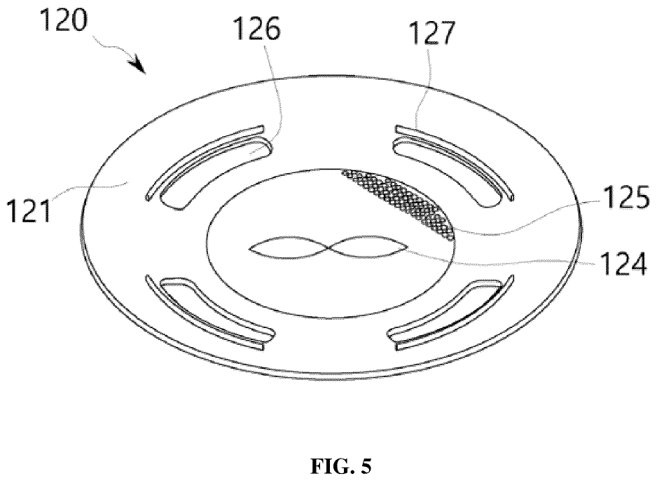

FIG. 2 is a flowchart of a method for making functional kimchi using Ecklonia cava according to one embodiment of the present invention. FIG. 3 is a detailed functional diagram of a mixing tank according to one embodiment of the present invention. FIG. 4 is a detailed functional diagram of a mixing container according to one embodiment of the present invention. FIG. 5 is a detailed functional diagram of a container lid according to one embodiment of the present invention.

Hereinafter, the present invention will be described in detail with reference to the attached drawings. The process comprises: preparing ingredients; forming a seasoning mixture; mixing the seasoning; maturing the seasoning mixture; and mixing the seasoning with cabbage.

The ingredient preparation process begins with preparing functional kimchi using Ecklonia cava (S110). Various seasoning ingredients, including Ecklonia cava, are prepared while preparing pickled cabbage (S120).

The seasoning ingredients include Ecklonia cava powder, kelp powder, Korean soy sauce, yeast cells, dried garlic, ginger, red pepper powder, salted seafood, glutinous rice paste, thread onions, sugar, and a titanium dioxide solution. Additional ingredients may be added to suit the consumer's preferences and desired functionality.

The seasoning mixture is prepared by adding 12.2 parts by weight of Ecklonia cava powder, 1.3 parts by weight of kelp powder, 7 parts by weight of sea grape powder, 1 part by weight of shiitake mushroom powder, 0.5 parts by weight of Korean soy sauce, 0.7 parts by weight of yeast cells, 20 parts by weight of minced garlic, 5 parts by weight of ginger, 12 parts by weight of red pepper powder, 25 parts by weight of salted seafood, 4.32 parts by weight of glutinous rice paste, 6 parts by weight of thread onions, 6 parts by weight of large green onions, 5 parts by weight of plum enzyme solution, 5 parts by weight of raw water parsley, 20 parts by weight of onion, 10 parts by weight of apple, and 5 parts by weight of sugar, based on 100 parts by weight of pickled seafood.

The 25 parts by weight of salted seafood can be replaced with 10 parts by weight of shrimp salted seafood, 10 parts by weight of anchovy salted seafood, and 5 parts by weight of fish sauce.

Kelp powder, sea grape powder, shiitake mushroom powder, and Ecklonia cava powder are dried. Generally, when drying raw ingredients, the weight is reduced by 30%. Therefore, when using raw ingredients, an additional 30% is added. Furthermore, each ingredient may have a 5-10% increase or decrease due to measurement errors. Raw ingredients such as kelp, sea grape, and Ecklonia cava can be referred to as “water kelp,” “water sea grape,” and “water Ecklonia cava.”

Meanwhile, 2.52 parts by weight of titanium dioxide solution is added to the composition.

100 parts by weight of pickled cabbage is the amount obtained after pickling approximately 5 heads of raw cabbage. The pickled cabbage will be described in detail below.

The titanium dioxide solution is made by mixing titanium dioxide (TiO2) powder with purified water at a weight ratio of 7 to 1, which is composed of nanoparticles with an average diameter of 500 to 700 nanometers (nm). The mixture is placed in a container and stored for 30 to 40 minutes to mature. During the maturation process, further mixing occurs naturally, and if the time exceeds 40 minutes, it is difficult to confirm the progress of natural mixing.

The Ecklonia cava powder, kelp powder, and sea grape powder are made by washing the Ecklonia cava, kelp, and sea grape separately to remove foreign substances, drying them for 1 to 2 hours in a room maintained at an internal temperature of 60 to 70 degrees Celsius and with a wind blowing at 4 to 5 meters per second, and then separating and drying them until they break easily when held by hand. The dried Ecklonia cava, kelp, and sea grape are then separated and placed in a mixer or grinder for 50 to 60 minutes and ground into particles with a diameter of 1 millimeter or less.

Ecklonia cava is a perennial seaweed belonging to the family Alariaceae and order Laminariales, distributed only in Japan and Korea. In Korea, it grows naturally along the southern coast, including Dokdo Island, the southern East Sea, and Jeju Island. It is used primarily as a food source for abalone and conch, and as a source of alginic acid [Kim, J. A. et al., Korean Acad Family Medicine (2004), 42:193-203].

Furthermore, the physiological activities of Ecklonia cava, including antioxidant, anti-inflammatory, anticancer, antihypertensive, and antidiabetic activities, have been reported [Athukorala Y et al., Food Chem Toxicol (2006), 44:1065-1074; Shin, H. C. et al., Arch pharm Res. (2006), 29:165-171; Kong C S et al., Food Chem Toxicol. (2009), 47:1653-165; Lee, S. H et al., J Sci Food Agric. (2009), 89:1552~1558].

Generally, plants produce substances that protect themselves from UV rays or prevent cell destruction. These substances are called polyphenols. Polyphenols are compounds containing multiple phenols. The more hydroxyl groups they contain, the greater their efficacy (by 2 to 4). Polyphenols are well known to have antioxidant, anti-inflammatory, cell regeneration, and blood circulation-enhancing effects in the human body.

They are a primary food source for sea turtles and abalone, symbols of longevity in the ocean.

Furthermore, Ecklonia cava is a plant that beneficially purifies marine pollutants and is a clean seaweed that prevents marine desertification. Living at depths of 30 to 40 meters, it protects itself from ultraviolet rays, protects cellular DNA, activates cell repair mechanisms, and produces polyphenols, a white chemical rarely found in terrestrial plants.

Meanwhile, Ecklonia cava regrows even from abalones or sea turtles that have been eaten, a natural gift from the ocean that has evolved over 170 million years. Approximately 14 types of polyphenols extracted from Ecklonia cava have been purified and used as pharmaceuticals. For example, sanol, isolated from Ecklonia cava, is a low-molecular-weight compound (CAF) with a 100-fold increased absorption rate. CAF is delivered directly to organ cells in the body and possesses both water- and fat-soluble properties. All animals and plants on Earth require solar energy to survive, but solar energy can also cause aging and disease. Animals and humans move to the shade to escape the scorching sun, but sessile plants cannot move, leaving them exposed to the sun's ultraviolet rays. To protect themselves from these rays, plants produce substances called polyphenols. Polyphenols are highly effective in restoring damaged cells to normal, and are considered a natural nutrient from the sea, possessing anti-inflammatory, antioxidant, anti-aging, and dementia-preventing properties.

A useful biotechnological extraction method has been reported that uses enzymes to break down the cell tissue of seaweed resources and recover various beneficial substances contained within the cells (Heo Su-jin et al., Food Industry and Nutrition, 2005, 10(1), pp. 31-41).

Thus, Ecklonia cava and its extracts are known as functional foods with excellent antioxidant and antihypertensive activities.

Lamina japonica, along with seaweed and laver, is one of the brown algae produced in Korean waters. Its unique savory flavor makes it a popular choice for making soups. Kelp is rich in minerals such as calcium, iodine, and zinc, and is also rich in dietary fibers such as alginic acid, fucoidan, and laminaran.

Donguibogam describes kelp as a functional food, called konpo, for its effects on promoting waste excretion, suppressing hypertension, arteriosclerosis, thyroid cancer, and nephritis, as well as inhibiting cancer cell proliferation and preventing aging.

Sea grape is described in the Jasaneobo (Korean Preface) of Jeongyakjeon as having a smooth texture, dark blue color, and mild flavor, enhancing the flavor of kimchi. It has long been used as an ingredient to enhance the flavor of kimchi, and can be added to dishes like dongchimi (Korean radish kimchi), water kimchi (Korean water kimchi), and baechu kimchi (Korean cabbage kimchi) for a refreshing flavor. Similar in appearance to deer antlers, sea grape is rich in iron, making it a functional food ingredient that helps prevent and improve anemia. It is particularly well-known as a beneficial ingredient for pregnant women.

Joseon Gukganjang (Korean soy sauce) is made by fermenting soybeans into meju (fermented soybeans) with bacteria (e.g., Bacillus subtilis) and molds, then adding salt water to the fermented soy sauce. It is also known as Joseon Ganjang, traditional soy sauce, Korean-style soy sauce, or Gukganjang (Korean soy sauce).

Yeast or yeast extract is produced by partially decomposing yeast cells. It is used as a microbial fermentation medium, a natural flavoring agent, and an ingredient in health foods.

Garlic, a perennial herb belonging to the lily family, is known to originate from Central Asia. It appears in South Korea's founding myth and is used as a seasoning in nearly all Korean dishes. In traditional Korean medicine, garlic is used for diuresis, expectoration, insecticide, deworming, stomach tonic, and diaphoresis.

Ginger, a perennial herb belonging to the Zingiberaceae family and Zingiberaceae, is known to originate from Southeast Asia. It is used for both food and medicine across many countries. Similar to potatoes, it propagates through tubers. It has a strong pungent, bitter, and astringent flavor. It is well known for its digestive, anti-inflammatory, immune-boosting, blood circulation-enhancing, indigestion-relieving and vomiting-relieving properties, weight loss, blood sugar control, heart health-promoting, pain relief, and anti-cancer effects.

The chili pepper is believed to have originated in Central and South America, and is known to be native to tropical regions. It is a member of the Solanaceae family, a temperate annual herbaceous shrub growing 6 to 9 cm tall and bearing many branches. Its leaves are long, round, and pointed, and it blooms white flowers in summer. Chili peppers have a unique spicy flavor (capsaicin) and a relatively strong aroma.

Jeotgal (fermented seafood) is made by fermenting fish. Some people avoid it due to the development of fishy odors, shortened fermentation periods, and poor color. However, some regions and social classes have selectively added various seafood ingredients, such as oysters, croaker, pollack, squid, shrimp, abalone, and sea grape, or jeotgal products to enhance nutritional value, enhance palatability, and diversify kimchi [Yoon, S. S. Korea agro-fisheries & food trade corporation (2008); Kim, S. S. Sookmyung women's university press (1985)].

Furthermore, seafood ingredients become a major source of nutrients, including lactic acid bacteria, vitamins, minerals, and amino acids. As the concept of seafood as a source of physiologically functional ingredients, including anticancer, blood pressure-regulating, bioactive, and antioxidant properties, has been introduced, interest in seafood as a kimchi ingredient is growing[Kim, S. B. et al., Korean. Fish. Soc. (1994), 27(1):1-6; Opstvedt J. 1984. Fish fats. Fats. Animal nutrition. Butterworth. 53].

Glutinous rice, primarily cultivated in Asia, contains approximately 374 kcal per 100 g. Unlike non-glutinous rice, it has a characteristic bitterness. However, when fermented, it retains a sweet flavor, leading to its traditional use as a kimchi seasoning.

Thread onions are a type of green onion, and are derived from the immature form of large green onions. They resemble chives, but are thinner and less bitter. They are often used as a seasoning ingredient or mixed with seasonings to make geotjeori (fermented vegetables). Rich in vitamins and fiber, they are often used for skin care and constipation relief, preventing skin aging.

Sugar is a powdered sweetener obtained by refining the juice or essence of sugarcane, sugar beets, sugar maples, palm trees, and sweetcorn, etc. It is primarily used for sweetening and has a relatively high caloric content.

Titanium dioxide (TiO2) is the ninth most common mineral on Earth, making up 0.6% of land veins and approximately 1% of the Earth's surface.

Titanium dioxide (TiO2) powder is typically prepared as nanoparticles with an average diameter ranging from 500 to 700 nanometers. Using particles with a diameter of 600 nanometers increases the surface area, resulting in increased photocatalytic efficiency and ease of handling.

Titanium dioxide (TiO2) powder particles with an average diameter of less than 500 nanometers tend to disperse easily in the wind and are relatively expensive. Nanoparticles with an average diameter of 700 nanometers or more exhibit a sharp drop in photocatalytic efficiency, falling below 70% compared to particles with a diameter of 500 nanometers.

Titanium dioxide (TiO2) powder mixed with clean water (purified water) at a weight ratio of 6:1 is preferable for handling because it prevents wind dispersal.

The term “photocatalyst” is a combination of the words “photochemistry” and “catalyst,” and refers to a catalyst that exhibits activity due to light energy. A catalyst generally speeds up or slows down a chemical reaction without changing itself. Chemical reactions typically use heat or other energy sources, but photocatalysis uses light as the energy source for the chemical reaction. When sunlight or artificial light is irradiated on the catalyst, the absorbed light energy activates the catalyst, oxidizing or reducing organic compounds.

Titanium dioxide is well known for its photocatalytic action, which decomposes harmful chemicals in the environment, transforming them into environmentally friendly substances, and sterilizing harmful bacteria.

In other words, titanium dioxide has the advantage of environmentally friendly removal of harmful compounds from crops, including cabbage, through its photocatalytic action.

Photocatalysts work by absorbing light energy, but do not require separate light irradiation; they are activated by naturally occurring light energy. The photocatalyst, titanium dioxide (TiO2), can absorb ultraviolet light with a wavelength of approximately 380 nm or less. A reaction occurs only when exposed to the corresponding amount of ultraviolet light. These ultraviolet rays lie between visible light and X-rays and are well known for their high penetrative power.

In the following description, the terms titanium dioxide, titanium oxide, and titanium dioxide are synonymous and will be used selectively as appropriate to the context.

This titanium dioxide (TiO2) nanopowder is an edible ingredient used as a raw material for white chocolate and is well known to be harmless to the human body.

It is described and understood that 100 parts by weight of pickled cabbage as five heads of average-sized raw cabbage soaked in clean water containing 2 kg of sea salt for five hours, then taken out and washed to remove foreign substances, and thereafter placed on a rack and dehydrated by gravity for two hours.

The seasoning mixing process involves sequentially adding the seasoning mixture adjusted during the formulation process to the mixing tank 100 in a specified order, mixing at a rate of 3 to 5 times per second. Mixing continues for 5 to 10 minutes after the final addition.

The prepared seasoning mixture is added as quickly as possible, preferably within 1 to 2 minutes.

The seasoning mixing process involves sequentially adding and mixing the following ingredients to the mixing tank 100: Korean soy sauce, yeast cells, minced garlic, ginger, red pepper powder, salted seafood, glutinous rice paste, thread onions, large green onions, plum enzyme solution, raw water parsley, onions, apples, sugar, kelp powder, sea grape powder, shiitake mushroom powder, Ecklonia cava powder, and titanium dioxide solution.

The mixing tank 100 comprises a mixing container 110, a container lid 120, and a mixing control unit 130.

The mixing container 110 is hemispherical in shape with an open top, forming a container. A seasoning mixture is introduced into the mixing container 110, and vibration is applied to the mixing container 110 in response to a corresponding control signal. The seasoning mixture is introduced into the mixing container 110.

The mixing container 110 comprises a container body 111, a container rotation shaft 112, a vibration transmission protrusion 113, and a container vibrator 114.

The container body 111 is hemispherical in shape with a downward recess and an open top, forming a container shape.

The container rotation shaft 112 is formed on the upper portion of the container body 111 to protrude outward in both directions and is positioned horizontally, forming a rotation axis that facilitates vibration of the container body 111.

The vibration transmission protrusion 113 protrudes downwardly and outwardly from the center of the lower surface of the container body 111.

The container vibrator 114 is connected to the lower end of the vibration transmission protrusion 113 and is configured to vibrate 3 to 5 times per second in response to a corresponding control signal from the mixing control unit 130. The container vibrator 114 is preferably configured as a stepper motor with an eccentric weight attached to the rotational shaft and easy to control rotation speed.

The container lid 120 opens and closes the open upper portion of the mixing container 110 by external force and mixes the seasoning mixture in response to a corresponding control signal.

The container lid 120 comprises a lid body 121, a lid handle 122, an electric motor 123, a mixing spatula 124, an ultrasonic vibrator group 125, a discharge hole 126, and a fixed protrusion 127.

The lid body 121 has a gently upwardly curved arc shape and opens and closes the open upper portion of the mixing container 110 by external force.

The lid handle 122 protrudes upward from the center of the lid body 121 and has a blunt upper portion to receive external force.

The electric motor 123 is installed inside the upper side of the lid handle 122 and rotates at a constant speed in response to a corresponding control signal from the mixing control 130. The rotational axis extends downward through the lid handle 122 and into the lower portion of the lid body 121.

The electric motor 123 is preferably a stepper motor, which facilitates easy rotational control.

The mixing spatula 124 is fixedly installed at one end of the rotational axis of the electric motor 123. It has a rod-like shape extending downward from the lid body 121, and a mixing spatula is fixedly installed at the other end.

The ultrasonic vibrator group 125 is arranged in a concave portion of the lower surface of the lid body 121 with one or more equally spaced apart elements and outputs ultrasonic signals in response to a corresponding control signal from the mixing control unit 130. The ultrasonic signals output from each ultrasonic vibrator of the ultrasonic vibrator group 125 vibrate the introduced seasoning mixture to ensure proper mixing. It is highly desirable to output ultrasonic signals at a frequency of 18 to 20 kHz to increase mixing efficiency.

The exhaust hole 126 is formed at the top and bottom of the concentric circumference of the lid body 121 and discharges vapor and odor generated from the mixing container 110 to the outside, thereby facilitating smooth and rapid mixing.

The fixed protrusion 127 is formed on the lower surface of the lid body 121 and protrudes from the outer edge of the exhaust hole 126. It contacts the upper inner surface of the mixing container 110 and supports the lid body 121 from slipping. It is preferable that the fixed protrusion 127 protrude 2 to 3 millimeters to prevent slipping even if the container lid 120 is deformed.

The mixing control unit 130 is connected to the mixing container 110 and the container lid 120 and outputs corresponding control signals in response to command signals.

The seasoning mixture aging process involves storing the seasoning mixture at an average room temperature of 30 to 35 degrees Celsius and a wind speed of 5 meters per second for 30 to 40 minutes.

The aging process allows the individual components of the seasoning mixture to be naturally well blended, and enables the characteristic flavors of the respective components to be sufficiently extracted. If the average temperature exceeds 35 degrees Celsius during the aging process, partial spoilage may occur. If the temperature falls below 30 degrees Celsius, aging will be delayed and take a relatively long time.

The cabbage seasoning mixing process involves evenly mixing the seasoning mixture, which has been aged during the aging process, onto the surface of the pickled cabbage.

The most fundamental and primary function of all foods is nutritional function, which maintains life and health. The secondary function is a hedonic function that satisfies the senses, including taste, smell, and vision. The tertiary function is generally categorized as a functional role of physiological regulation, such as biological defense, disease recovery, and anti-aging.

Meanwhile, to comprehensively study the diverse functions of foods, a research group led by President Fujimaki of Ochanomizu Women's University in Japan received funding from the Ministry of Education, Culture, Sports, Science, and Technology in 1984. During this period, they conducted research on “Systematic Interpretation and Development of Food Functions,” which led to the use of the term “functional foods,” which focused solely on the tertiary functions of foods. In the United States, the concept of “designer foods” emerged in cancer prevention research around the 1990s. In Korea, the concept of functional foods emerged in the 1990s, driven by a surge in research on the physiological activity of natural food ingredients.

In Korea, functional foods are defined under Article 3 of the “Health Functional Food Act” as foods manufactured (processed) using raw materials or ingredients with beneficial functional properties for the human body. The Japanese Ministry of Health, Labour and Welfare defines them as “foods whose ingredients are designed and processed to exert biological functions, such as biological defense, regulating body rhythms, and preventing and recovering from disease.”

Kimchi is a traditional Korean food made with salted vegetables and seasonings, fermented and aged. It is known to have biological rhythm regulating properties, such as promoting digestion and boosting immunity, etc. It also possesses antibacterial, anti-inflammatory, anti-mutagenic, and anti-cancer properties, which help prevent diseases and improve wound healing. It also lowers blood cholesterol, slows aging, and aids in weight loss. Kimchi's lactic acid bacteria are known to possess complex, high-functioning properties. Notably, an American health magazine selected it as one of the top five health foods to watch globally.

To improve kimchi quality, research on the addition of various additives, such as pollack, quince extract, water parsley, mulberry leaves, and gwamegi, etc. to enhance functionality and storage stability is increasing [Sung, J. M. et al., Korean J Food Preserv. (2009), 16(5): 772-781; Park, L. Y. et al., Korean J Food Preserv. (2008), 15(5): 669-674; Bae, M. S. et al., Korean J Food Cookery Sci. (2008), 24(5): 573-579; Shin, S. M. et al., Korean J Food & Nutr. (2007), 20(1): 53-62; Jung, Y. K. et al., Korean J Food Preserv. (2007), 14(5): 526-530].

Research has shown that lactic acid bacteria produced during the fermentation (ripening) process of kimchi can eliminate harmful microorganisms and even suppress coronavirus infection. Research on microorganisms used in traditional fermented foods such as yogurt and cheese is active overseas. In France, in particular, genome research on Lactococcus lactis, a microorganism used in cheese processing, is known to be active.

The present invention, with its structure, improves storage by processing Ecklonia cava and mixing it with readily available seasoning ingredients to produce kimchi using a standard method, making it easy for anyone to produce functional kimchi. Furthermore, by mixing harmless nanoparticle-sized titanium dioxide powder into the seasoning ingredients, it offers the advantage of environmentally friendly decomposition and removal of various harmful compounds that have penetrated crops during the kimchi ripening process.

While the present invention has been described in detail with respect to the specific examples described above, it will be apparent to those skilled in the art that various modifications and variations are possible within the scope of the present invention, and such modifications and variations are naturally within the scope of the appended claims.

### EXPLANATION OF SYMBOLS

100: Mixing tank
110: Mixing container
111: Container body
112: Container rotation shaft
113: Vibration transmission protrusion
114: Container vibrator
120: Container lid
121: Lid body
122: Lid handle
123: Electric motor
124: Mixing spatula
125: Ultrasonic vibrator group
126: Discharge hole
127: Fixed protrusion
130: Mixing control

1. A method for manufacturing functional kimchi using Ecklonia cava, comprising:
a process for preparing seasoning ingredients, each including pickled cabbage and Ecklonia cava;
a process for preparing a seasoning mixture, for seasoning the pickled cabbage, the seasoning mixture comprising: 12.2 parts by weight of Ecklonia cava powder, 1.3 parts by weight of kelp powder, 7 parts by weight of sea grape powder, 1 part by weight of shiitake mushroom powder, 0.5 parts by weight of Korean soy sauce, 0.7 parts by weight of yeast cells, 20 parts by weight of minced garlic, 5 parts by weight of ginger, 12 parts by weight of red pepper powder, 25 parts by weight of salted seafood, 4.32 parts by weight of glutinous rice paste, 6 parts by weight of thread onions, 6 parts by weight of large green onions, 5 parts by weight of plum enzyme solution, 5 parts by weight of raw water parsley, 20 parts by weight of onion, 10 parts by weight of apple, and 5 parts by weight of sugar, based on 100 parts by weight of pickled cabbage;
a seasoning mixing process in which the seasoning mixture prepared in the above-mentioned process for preparing the seasoning mixture is sequentially added to a mixing tank in a designated order, mixing at a rate of 3 to 5 times per second, and mixing for 5 to 10 minutes after the seasoning mixture is completed;
a seasoning mixture maturation process in which the seasoning mixture prepared in the above-mentioned seasoning mixing process is stored for 30 to 40 minutes at room temperature of 30 to 35 degrees Celsius and in an environment with a wind speed of 5 meters per second;
a cabbage seasoning mixing process in which the seasoning mixture prepared in the above-mentioned seasoning mixing maturation process is uniformly mixed on a surface of pickled cabbage.

2. The method according to claim 1, characterized in that the 25 parts by weight of the salted seafood is replaced with 10 parts by weight of shrimp salted seafood (salted seafood), 10 parts by weight of anchovy salted seafood, and 5 parts by weight of fish sauce.

3. The method according to claim 1, the seasoning mixture further comprises 2.52 parts by weight of a titanium dioxide solution, and the titanium dioxide solution comprises titanium dioxide (TiO2) powder comprising nanoparticles having an average diameter of 500 to 700 nanometers (nm) and purified water, mixed in a weight ratio of 7 to 1, placed in a container, and stored for 30 to 40 minutes to mature.

4. The method according to claim 3, wherein:
the Ecklonia cava powder, the kelp powder, and the sea grape powder are produced by:
a drying step in which the Ecklonia cava, kelp, and sea grape are separated and washed to remove foreign substances, and dried for 1 to 2 hours in an indoor environment maintained at an internal temperature of 60 to 70 degrees Celsius and with a wind blowing at 4 to 5 meters per second, thereby separating and drying them into easily broken pieces; and
a grinding step in which the dried Ecklonia cava, the kelp, and the sea grape dried in the drying step are separated, placed in a mixer or grinder for 50 to 60 minutes, and ground into particles of 1 millimeter or less in diameter.

5. The method according to claim 4, the pickled cabbage is prepared by soaking five heads of raw cabbage in clean water containing 2 kg of sea salt for five hours, washing them, and then dehydrating them by placing them in a container for two hours, the seasoning mixing process comprises sequentially adding and mixing a solution of Korean soy sauce, yeast cells, minced garlic, ginger, red pepper powder, salted seafood, glutinous rice paste, thread onions, large green onions, plum enzyme solution, raw water parsley, onions, apples, sugar, kelp powder, sea grape powder, shiitake mushroom powder, Ecklonia cava powder, and titanium dioxide to the mixing tank (100).
